(19) United States
(12) Patent Application Publication
(10) Pub. No.: US 2006/0158031 A1
(43) Pub. Date: Jul. 20, 2006

(54) Method and system for controlling the driving stability of a vehicle and use of said system

(75) Inventors: Martin Kummel, Spangenberg (DE); Frank Steinmeier, Hofheim (DE); Rafael Kumschier, Eschborn (DE)

Correspondence Address: Craig Hallacher;Continental Teves Inc, One Continental Drive, Auburn Hills, MI, 48326, US

(73) Assignee: Continental Teves AG & Co. oHG

(21) Appl. No.: 10/546,442

(22) PCT Filed: Feb. 19, 2004
(86) PCT No.: PCT/EP04/50164

§ 371 Date: Aug. 19, 2005

(30) Foreign Application Priority Data
Feb. 20, 2003 (DE) 103 07 405.8

(51) Int. Cl. B60T 8/60

(52) U.S. Cl. 303/146

(57) ABSTRACT

The present device relates to a system and method for controlling the driving stability of a vehicle utilizing variables that characterize a driving situation of the vehicle and are detected in a process. The system and method include determining an expected future behavior of the vehicle, checking the expected future driving behavior with respect to a critical driving situation and executing a vehicle intervention during stable driving conditions to prevent the vehicle from entering a critical driving situation. The intervention may include a brake intervention or an engine intervention.

### BACKGROUND OF THE INVENTION

The present invention relates to a method for controlling the driving stability of a vehicle wherein variables characterizing a driving situation of the vehicle are detected in a process.

The invention further relates to a system appropriate for implementing the method and to the use of the system.

Prior-art driving dynamics control systems detect the vehicle behavior by means of appropriate sensors and compare the vehicle behavior, which is influenced by the driver among others by way of the steering system, with the reference behavior for the vehicle. Discrepancies between the vehicle behavior and the reference behavior are controlled by brake interventions and engine interventions.

Among these systems are above all embodiments of brake slip control (ABS) meant to prevent individual wheels from locking during a brake operation, traction slip control (TCS) meant to preclude spinning of the drive wheels, the electronic brake force boosting (EBV) for controlling the ratio between the brake force at the front axle and at the rear axle, anti rollover braking (ARB) for preventing rollover of the vehicle about its longitudinal axis, and yaw torque control (ESP) for stabilizing the vehicle in a yawing motion.

However, the above control systems react only when a deviation of the vehicle behavior from the reference behavior has already been detected. Thus, they are only in a position to improve the vehicle behavior in a critical driving situation, yet they are unable to prevent critical driving situations.

In particular when the driver provokes a critical driving situation by adjusting safety-critical steering angle velocities or steering angles, respectively, it is initially necessary for the control systems to detect the reaction of the vehicle before they can intervene into driving dynamics. Thus, the driver can force a vehicle into safety-critical situations which may cause skidding or rollover.

In this regard, U.S. National Highway Traffic Safety Administration (NHTSA) planned to perform a test with respect to the Rollover Resistance in order to check a vehicle in the described situation. FIG. 1 illustrates the high demands placed on the vehicles in this test.

It is desirable that driving dynamics control systems can reliably detect and prevent any possible critical driving situations at an early time. Some systems for the early detection of driving situations with a safety hazard are known in the art.

Thus, international patent application WO 02/36401 A1 discloses a method for controlling the driving stability, wherein it is determined on the basis of a stable driving behavior whether there is a tendency to a subsequent unstable driving behavior due to a highly dynamic steering maneuver, and pre-intervention of the brake will take place already at a stable driving behavior in this case. Based on the comparison of the sensed steering wheel angle velocity, the yaw rate, and/or the lateral acceleration with predetermined threshold values it is judged whether the vehicle shows a tendency to unstable driving behavior.

This prior art method differs from the methods which are the basis for the systems reacting to a critical situation in that said method becomes active already when the vehicle is still showing a stable behavior. However, like the prior art reactive methods, it founds on the comparison of actual data with threshold values that lead to expect an unstable driving behavior. These values must be determined from tests by means of a reference model of the vehicle, with the problem being encountered that individual driving situations, which are e.g. determined by the instantaneously prevailing load of the vehicle and the condition of the underground, cannot be taken into account comprehensively, or only by entailing considerable efforts.

### SUMMARY OF THE INVENTION

Starting from the illustrated state of the art, an object of the invention is to improve upon a generic method and a generic system in such a fashion that driving situations with a safety hazard are more reliably detected at an early time and prevented more effectively.

According to the invention, this object is achieved by a method that determines driver actions, determines expected future driving behavior of the vehicle, checks if the behavior will be a critical driving situation and executes an intervention while the vehicle is in a stable driving condition.

Further, the object is achieved by a system that determines driver actions, determines expected future driving behavior of the vehicle, checks if the behavior will be a critical driving situation and executes an intervention while the vehicle is in a stable driving condition.

According to the invention, a method is implemented for controlling the driving stability of a vehicle, wherein variables characterizing the driving behavior of a vehicle are detected in a process, a driver action is determined from the detected variables, a driving situation to be expected in future due to the driver action is defined and this driving situation is checked with respect to whether the driving situation is critical. If the driving situation to be expected is assessed as being critical, brake interventions and/or engine interventions are executed already when a stable driving behavior prevails, said interventions changing the driving situation in such a fashion that the driving situation that has to be expected in view of the driver action will not occur.

Thus, the method involves that the driving behavior is monitored and the driving situation to be expected in future is evaluated in order to detect critical driving situations at an early time. Hence, the invention goes beyond testing the instantaneous driving situation which serves as an indicator of future driving behavior in the prior art method. The prediction of the driving behavior to be expected, according to the invention, is based on the detected driver action and is, thus, more reliable and better adapted to situations than a calculation of the future vehicle behavior from the actual data of driving dynamics and limit values linked thereto which are determined in a vehicle model with a skilled driver.

A typical driver action which can lead to a safety-critical driving situation is e.g. a steering movement with a very great steering wheel angle gradient. The method of the invention allows determining from the driving-dynamics relevant variables, which are measured when this steering movement is initiated, the values of these variables to be expected, and allows comparing them with predetermined situation-responsive limit values. When the limit values are exceeded, corresponding brake and/or engine interventions can be performed to avoid the occurrence of a critical driving situation.

Another advantage of the method of the invention is that it can be integrated into the implementation of an electronic driving stability program.

It is therefore especially favorable that the process in which the relevant variables are measured concerns a driving stability program for vehicles.

In a preferred embodiment of the method, at least the process variables steering wheel angle and/or steering angle and vehicle speed are measured, and the term ‘vehicle speed’ implies the speed of the center of gravity of the vehicle.

An early, critical vehicle situation can e.g. be determined in that the driver action is determined by means of an instantaneous lateral acceleration a_{y1} that is produced from the process variables ‘steering angle’ and ‘vehicle speed’ by taking into account vehicle constants.

It is favorable to this end that the lateral acceleration a_{y1} is determined which the vehicle would reach if the driver continued driving with the currently adjusted steering angle.

An early critical vehicle situation can be determined in a particularly preferred embodiment of the method in that the driver action is determined by means of a lateral acceleration a_{y2} which is produced from the process variables ‘steering angle speed’ and ‘vehicle speed’ and has to be expected in future.

It is favorable in this arrangement that the lateral acceleration a_{y2} to be expected in future is determined, which the vehicle would reach if the driver continued driving into or out of a bend with almost the same steering velocity.

When determining the critical vehicle situation, it is furthermore advantageous that the determined variables of the lateral accelerations a_{y1}, a_{y2} are compensated with respectively one or at least one limit value.

A critical vehicle situation is favorably eliminated because the brake interventions are carried out on at least one wheel.

Furthermore, a critical driving situation is favorably eliminated because the vehicle speed is reduced by the brake interventions.

The yaw rate of the vehicle is another example of a driving-dynamics relevant variable which can be monitored by means of the method of the invention.

A critical driving situation can be detected in that actual rotation data measured by means of a yaw rate sensor and/or yaw angle sensor are compared with nominal rotation data. As this occurs, it is favorable that the nominal rotation data are determined from the process variables in a vehicle model.

It is preferred that a yaw rate to be expected in future is determined based on the measured actual yaw rate data. The yaw rate to be expected can be compared with nominal rotation data in order to detect a driving situation with a safety hazard due to a driver action at an early time.

If any one of the comparisons leads to expect a critical driving situation, it is possible that the brake interventions, depending on actual and nominal rotation data, force an additional torque about the vertical axis of the vehicle, meaning a yaw torque which compensates the driver action.

It is then arranged for that signals for a pressure requirement aiming at a brake pressure increase and/or brake pressure reduction in the wheel brakes are generated in a driving dynamics control, which pressure requirement causes a determined additional torque or a determined speed reduction of the vehicle, and the corresponding commands are output to the actuators.

The intensity of the brake intervention is favorably determined in that the signals for the brake pressure increase and/or brake pressure reduction are produced depending on the variables of the lateral accelerations a_{y1}, a_{y2} and/or the vehicle speed and/or the actual lateral acceleration and/or the steering wheel angle.

It is favorably provided that the brake and/or engine torque intervention is terminated when the expected critical driving situation fails to appear or an actual critical driving situation is no longer determined.

A condition for leaving the control is that the critical driving situation is no longer determined when the variables of the lateral accelerations a_{y1} and a_{y2} are below predetermined threshold values.

Besides, the invention offers a system which is appropriate for implementing the method of the invention. The term ‘system’ herein especially implies a device in which the components cooperate.

The system for controlling the driving stability of a vehicle comprises sensors, which characterize the driving behavior of the vehicle and measure variables taken into account in a process, a unit for evaluating the measured values of the variables, and a means for generating control signals for controlling a brake and/or engine intervention.

The system further comprises a means for determining a driver action from the values of the variables measured during a process, a means for determining values of variables that characterize a driving dynamics of the vehicle and can be derived from the measured variables and vehicle constants, said values to be expected in future due to the determined driver action, a means of comparison for comparing the values of these variables to be expected with threshold values for these variables and for checking whether a critical driving situation must be expected, and in addition comprises a means for controlling brake and/or engine interventions depending on the result of the comparison.

When the result of the comparison is that a critical driving situation has to be expected, this situation can be prevented by appropriate brake and/or engine interventions.

In a preferred embodiment, the system comprises at least one sensor for detecting the vehicle speed and a sensor for detecting the steering angle and/or the steering wheel angle.

It is also very favorable that the system also comprises a sensor for detecting the yaw rate of the vehicle.

Another advantage of the system involves that it can be integrated into a driving stability control such as ABS, TCS, ESP and a similar system.

The system is further suited in a very favorable way for use in a device for preventing rollover of a vehicle.

Further advantageous ways of implementing the method of the invention and further favorable embodiments of the system of the invention can be taken from the following illustration of preferred embodiments of the invention by way of the accompanying drawings.

### BRIEF DESCRIPTION OF THE DRAWINGS

In the drawings:

FIG. 1 is an illustration of the test conditions of the NHTSA test for determining the Rollover Resistance Rate;

FIG. 2 is a schematic view of a vehicle with a brake control system.

### DETAILED DESCRIPTION OF THE DRAWINGS

Each vehicle has, likewise at a high coefficient of friction, a maximum lateral acceleration which depends on the roadway-tire material pairing, on the chassis and, eventually, on the center of gravity of the vehicle. Tests have shown that unskilled drivers will mostly steer too late and often excessively in dangerous situations, thus exceeding the physical limits of the vehicle.

It is preferred to use the system in a driving dynamics control system such as ABS, TCS, ESP, etc., or in a device for rollover prevention of vehicles. Vehicles being equipped with these systems are already provided with the necessary sensor equipment and include the required actuators.

The method of the invention and the system of the invention are used to avoid vehicle instabilities which may occur due to abrupt steering and countersteering reactions as possibly encountered in an obstacle avoidance maneuver, during lane changes, and like maneuvers. In particular in vehicles with a high center of gravity there is a major risk of rollover in these maneuvers.

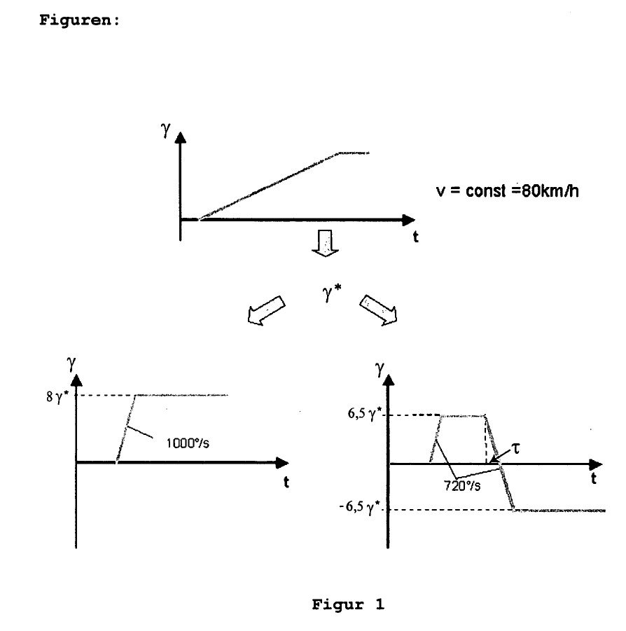

The driving situations referred to hereinabove are e.g. provoked in the tests planned by the U.S. NHTSA in order to determine the Rollover Resistance of vehicles. The envisaged maneuvers are illustrated in FIG. 1.

Initially, the steering wheel turn and, hence, the steering wheel angle γ is increased slowly at a constant vehicle speed of v=80 km/h until the centrifugal acceleration at the vehicle's center of gravity amounts to 0.3 g. With the corresponding steering wheel turn, the steering wheel angle γ is determined which corresponds to this turn.

The actual test comprises a ‘J-turn’ and a ‘fishhook’ maneuver.

In the ‘J-turn’ maneuver, the steering wheel angle γ is raised with a steering angle gradient γ from 1000°/s to a value of 8 γ.

The ‘fishhook’ maneuver is characterized in that the steering wheel angle γ initially at a steering wheel angle gradient γ of 720°/s is raised to an angle γ of 6.5 γ° and is then maintained constant until at time τ the maximum roll angle is reached, that means the maximum deflection of the vehicle with respect to a rotation about its longitudinal axis. Subsequently, the steering wheel is turned back until a steering wheel angle γ of −6.5 γ° is reached. The change of the steering wheel angle γ when steering back to the original course shall correspond also to a steering wheel angle gradient γ of 720°/s.

Positive or negative steering wheel angles γ correspond to right-hand or left-hand curves, or vice-versa. It is not important which direction corresponds to which sign.

Thus, very great steering angles γ and very high steering angle gradients δ appear in the described maneuvers. Overturning or rollover of the vehicle may occur especially in an obstacle avoidance maneuver with countersteering at a high coefficient of friction that is simulated by the ‘fishhook’ maneuver.

In general, two driver actions have been found in the preparation of the invention which, occurring individually and jointly, must be assessed as critical.

They cause a swerving hazard and, at high coefficients of friction, may even cause overturning or rollover of the vehicle, respectively.

The actions concerned are
a) steering with a very high gradient, and
b) ‘oversteering’, meaning that the driver adjusts a steering angle δ which significantly exceeds the physical possibilities of the vehicle.

Likewise the NHTSA test described hereinabove founds on a consideration of these critical driver actions. In particular in vehicles which, with respect to their track width, have a very high center of gravity, these driver actions can cause an uncontrolled turning into a bend and rollover in the worst case. Among the vehicle species with a special safety hazard are e.g. LTV (Light Trucks and Vans) and SUV Sports Utility Vehicles) vehicles.

The invention at issue provides a method and a system, which reliably and early detect such driver actions and avoid safety-critical situations by appropriate brake and/or engine interventions.

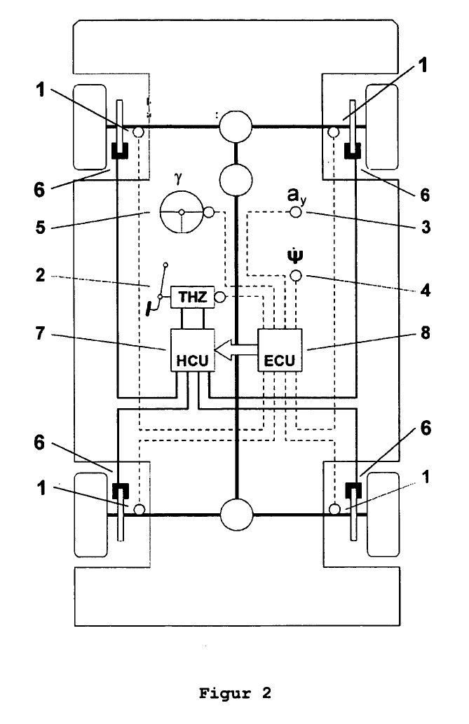

To this effect, the invention makes use of the system comprising sensors and actuators which is are typically provided in vehicles with an ESP system. The ESP sensor equipment and the brake control system of a vehicle of this type are shown schematically in FIG. 2.

The ESP system comprises a wheel speed sensor 1 for each of the four wheels of the vehicle, a tandem master cylinder (TMC) pressure sensor 2, a lateral acceleration sensor 3 for determining the lateral acceleration a_{y}, a yaw rate sensor 4 for detecting the yaw rate \dot{Ψ} and a steering wheel angle sensor 5 for detecting the steering wheel angle γ.

The test signals of the sensors are transmitted to the vehicle processor system (ECU) 8, as is indicated by the dotted lines in FIG. 2.

It is assumed in this embodiment that the vehicle is equipped with a hydraulic brake. The use of an electro-hydraulic or electromechanical brake is, however, also possible.

In a hydraulic brake system, the brake pressure is built up by the driver by way of the brake pedal actuating a master brake cylinder (TMC), and the brakes 6 at the individual wheels are connected to the master cylinder (TMC) by way of inlet valves. Outlet valves, through which the wheel brakes 6 are in connection to a non-pressurized reservoir or a low-pressure accumulator, control a reduction of the brake pressure. The inlet and outlet valves are electromagnetically operated for pressure control.

In addition, an auxiliary pressure source is provided that is used to build up brake pressure in the wheel brakes 6 independently of the position of the brake pedal.

The brake pressure in the master cylinder (TMC) is adjusted by application of the brake pedal so that the TMC pressure sensor can be replaced by a pedal-travel or pedal-force sensor in order to sense the braking request of a driver. A TMC pressure can then be associated with the test signals in each case.

Similarly, a steering angle sensor can replace the steering wheel angle sensor 5 because there is a predefined relationship between the steering angle δ of the front wheels and the steering wheel angle γ.

The master cylinder (TMC) of the hydraulic brake system his connected by way of hydraulic lines to a hydraulic unit (HCU) 7 for actuating the brakes 6. The hydraulic unit (HCU) 7 receives control signals from the vehicle processor system (ECU) 8 and permits an individual actuation of the single wheel brakes 6, as it is executed by an ESP.

The interaction of the individual components of the brake system takes place by way of hydraulic lines which are schematically shown in FIG. 2 by solid lines.

The first approach of the invention relates to the detection of the physical lateral acceleration limit and the cornering force which the driver demands from the vehicle.

It is then determined whether a steering request of the driver comprises a steering angle δ or a steering angle gradient δ, respectively, which is of such a magnitude that the lateral acceleration a_{y} that has to be expected due to the steering request exceeds a predetermined threshold value.

The lateral acceleration a_{y} to be expected due to the steering request is determined in the fashion that will be described hereinbelow:

Between the vehicle speed v, the lateral acceleration a_{y} and the yaw rate \dot{Ψ} there is, on the one hand, the relation
\dot{Ψ}·ν=α_{y} (I)
where the variables are related to the center of gravity of the vehicle.
On the other hand,

$$\dot{Ψ} = \frac{δ \cdot v}{l + {v}^{2} \cdot E G} \qquad ( II )$$

also applies to the yaw rate \dot{Ψ}, this term also implying a dependency of the yaw rate \dot{Ψ} on the steering angle δ and the so-called self-steering gradient EG. The self-steering gradient EG of the vehicle indicates the self-steering behavior of the vehicle, that means the steering properties at the lateral acceleration a_{y} independent of a driver's influence. Depending on whether the self-steering gradient EG is higher than zero, equal to zero, or lower than zero, the vehicle behaves in an oversteering, neutral, or understeering fashion. This results from the fact that the variable EGa_{y} indicates exactly the difference of the tire slip angles on the front and rear axles. Reference numeral 1 designates the wheel base of the vehicle.

The terms (I) and (II) for the yaw rate \dot{Ψ} can be equated and solved with respect to a_{y} in order to achieve a term for the lateral acceleration a_{y} depending on the vehicle speed v, the sensed steering angle δ and the vehicle-responsive parameters of wheel base 1 and self-steering gradient EG:

$${a}_{y 1} = \frac{δ \cdot {v}^{2}}{l + {v}^{2} \cdot E G} . \qquad ( III )$$

This term indicates the instantaneous lateral acceleration a_{y1} of the vehicle in particular in dependence on the instantaneous (measured) steering angle δ. The variable a_{y1} thus corresponds to the lateral acceleration, at which the vehicle would theoretically ride in a constant circular travel with the currently adjusted steering angle δ.

The instantaneous lateral acceleration a_{y1} can also be measured by means of the lateral acceleration sensor 1.

When the value of a_{y1} exceeds a defined, situation-responsive limit value (e.g. 9-11 m/s²), it can be assumed that the steering angle of the driver is excessive for the current speed v. This means a critical driving situation exists which can cause unstable driving behavior and, at a high coefficient of friction, also rollover of the vehicle.

However, the term (III) in this form still does not allow the forecast according to the invention regarding the lateral acceleration a_{y} that has to be expected and desired or provoked by the driver by way of its steering behavior, when the driver continues changing the steering angle δ.

However, a behavior of this special type is frequently observed in unforeseen obstacle avoidance maneuvers.

The difference between the steering angle δ against time t and the instantaneous steering angle, however, results under the precondition of a constant steering angle gradient \dot{δ} to \dot{δ}t. The invention aims at predicting the lateral acceleration for a short time t after the measurement of the lateral acceleration a_{y} or of the variables determining the latter.

The time during which the forecast shall be directed into the future is referred to as LcPaytime and amounts up to 1 s. A typical value which takes into account the steering performance of the driver and the response behavior of the electronic and the brake systems and the vehicle amounts to 300 ms.

The lateral acceleration a_{y2} to be expected on account of the driver action is thus achieved by the term

$${a}_{y 2} = \frac{( δ + \dot{δ} \cdot LcPaytime ) \cdot {v}^{2}}{l + {v}^{2} \cdot E G} . \qquad ( IV )$$

The lateral acceleration a_{y2} comprises the theoretical lateral acceleration a_{y}, which the vehicle would have in the future (in the time LcPaytime) if the driver continues driving into or out of a bend with a uniform steering velocity δ.

The steering angle gradient \dot{δ} can be determined from two values of the steering wheel angle γ being measured in short succession or of the steering angle δ.

When the signal a_{y2} exceeds a defined, situation-responsive limit value (e.g. 6-15 m/s²), it can be assumed that the steering angle of the driver within a short period will be too great for the current speed. This means it must be assumed that a critical driving situation will soon prevail that may lead to unstable driving behavior and, at a high coefficient of friction, can even cause rollover of the vehicle.

Thus, the signals a_{y1} and a_{y2} allow a reliable and, in particular by way of the signal a_{y2}, early detection of a driver action which can lead to a critical driving behavior. In order to prevent the occurrence of critical driving situations, the brake control system is activated which can reduce the vehicle speed by means of brake intervention and/or force the vehicle into an understeering maneuver due to an asymmetric brake intervention. The pressure increases can then go beyond the wheel lock pressure level in order to purposefully reduce the cornering force at the wheels undergoing intervention.

The situation-responsive limit values are determined at a reference vehicle and stored in the vehicle processor system (ECU).

The vehicle processor system (ECU) comprises a means for determining the lateral accelerations a_{y1} and a_{y2} from the data transmitted by the sensor equipment of the overall system.

The instantaneous lateral acceleration a_{y1} can be calculated according to the term (III) by the means for determining the lateral acceleration or can result directly from the test signal of the lateral acceleration sensor 3.

To calculate the instantaneous lateral acceleration, the means receives the test signals of the steering wheel angle sensor 5 and the signals of the wheel speed sensors 1 from which the vehicle speed v can be determined.

The vehicle constants such as wheel base 1 and self-steering gradient EG are stored in the vehicle processor system (ECU) 8.

The redundant measurement also allows checking the function of the sensors by means of the vehicle processor system (ECU) 8. Thus, the comparison of the calculated value of a_{y1} with the test signal allows checking the test signal of the steering angle sensor 5.

The system further has a comparison means comparing the values for the lateral accelerations a_{y1} and a_{y2} that have been determined by way of the test data transmitted from sensors, with the stored limit values. In dependence on the result of the comparison, the vehicle processor system (ECU) generates corrective signals, which are transmitted to the hydraulic unit (HCU) 7 and initiate a brake intervention. The transmission of the corrective signals is shown schematically in FIG. 2 by means of an arrow.

The limit values are responsive to the situation in a preferred embodiment of the invention. In case there is corresponding sensor equipment, they can take into consideration the weather, road pavements, and possibly further parameters.

The intensity of the brake intervention can then be dependent on the signals a_{y1} and a_{y2} and on the driving speed v, the actual lateral acceleration a_{y1}, the steering angle δ.

All variables or the corresponding test signals, respectively, are processed by the vehicle processor system (ECU) 8, which subsequently generates corresponding control signals and sends them to the hydraulic unit (HCU) 7. This unit will then actuate the wheel brakes 6 in response to the control signals.

As this occurs, brake intervention is preferably executed either at the front wheels or at the outside front wheel in a turn. In particular if intensive brake intervention becomes necessary, it is preferred to slow down both front wheels because braking of the outside wheel in a turn alone could generate an excessive yaw torque so that the vehicle might be skidding.

However, in less intensive brake interventions it is preferred to brake the outside wheel in a turn in order to force the vehicle into an understeering maneuver. This can further be achieved in that a wheel is braked to such a great extent that it locks for a short interval. This causes a reduction of cornering force and can also bring about understeering of the vehicle. Thus, the brake system is controlled analogously to the control by way of an ESP system.

In a favorable embodiment, the system of the invention in addition comprises a means for engine intervention. This means permits braking the vehicle by means of reducing the engine torque in order to avoid safety-critical driving situations. In this arrangement, engine intervention can be executed in addition to brake intervention.

Furthermore, it is especially favorable when the yaw rate \dot{Ψ} determined from the test signals of the yaw rate sensor 4 is taken into consideration in the control of the brake and/or engine interventions.

This factor allows controlling the brake and/or engine interventions in such a fashion that an additional yaw torque is forced which counteracts a safety-critical yaw motion.

Also, arrangements may be made in this respect to determine in addition to the instantaneous yaw rate \dot{Ψ} also that yaw rate \dot{Ψ}₁ which would occur if the driver continued driving into or out of a bend at a uniform steering velocity \dot{δ}.

Analogously to the relation (IV), the yaw rate \dot{Ψ}₁ is achieved from the term (II) with

$${\dot{Ψ}}_{1} = \frac{( δ + \dot{δ} \cdot LcPaytime ) \cdot v}{l + {v}^{2} \cdot E G} . \qquad ( V )$$

The expected yaw rate determined therefrom can be compared with a maximum yaw rate determined by way of a reference model of the corresponding vehicle, the maximum yaw rate ensuring a safe driving situation. When the value of the yaw rate to be expected exceeds this maximum yaw rate, the vehicle processor system can initiate a correcting brake and/or engine intervention at an early time.

The brake intervention and/or engine intervention can be terminated as soon as the critical driving situation is overcome and/or the values of a_{y2} and Ψ₁ or \dot{Ψ}₁ can lead to expect a safe driving situation.

This condition can e.g. be detected when the signals a_{y1} and a_{y2} fall short of determined limit values (e.g. 5-10 m/s²).

Thus, the invention provides a favorable method and a system allowing early detection of driving situations with a safety hazard and, hence, avoiding their occurrence.

Thus, the invention goes beyond making available a reactive system that intervenes in the event of existing vehicle instability (e.g. deviation of the measured yaw rate \dot{Ψ} from the nominal yaw rate, exceeding of the lateral acceleration threshold). The invention rather comprises a system that is foresightedly activated in expectation of future instability.

As this occurs, the driver action plays the predominant role, and an enormous advantage in time is achieved because there is no need to wait for vehicle reactions.

### LIST OF REFERENCE NUMERALS

1 wheel speed sensor
2 tandem master cylinder (TMC)—pressure sensor
3 lateral acceleration sensor
4 yaw rate sensor
5 steering wheel angle sensor
6 wheel brake
7 hydraulic unit
8 vehicle processor system
ECU vehicle processor system
HCU hydraulic unit
THZ tandem master cylinder
a_{y} lateral acceleration
a_{y1} instantaneous lateral acceleration
a_{y2} lateral acceleration to be expected
δ steering angle
\dot{δ} steering wheel angle gradient
EG self-steering gradient
γ steering wheel angle
\dot{γ} steering wheel angle gradient
γ* steering wheel angle at 0.3 g
l wheel base
\dot{Ψ} yaw rate
\dot{Ψ}₁ yaw rate to be expected
t time
τ time at which the vehicle has reached its maximum roll angle
v vehicle speed

1-25. (canceled)

26. A method for controlling driving stability of a vehicle using variables that characterize a driving situation of the vehicle, the method comprising:
determining driver actions from detected variables;
determining an expected future driving behavior of the vehicle based on the determined driver actions;
checking the expected future driving behavior with respect to a critical driving situation; and
executing at least brake interventions or engine interventions during stable driving behavior when a critical driving situation is expected in the future.

27. The method according to claim 26, wherein the variables are determined by an electronic driving stability program process.

28. The method according to claim 26, wherein the variables include at least one of a vehicle speed, a steering wheel angle and a steering angle.

29. The method according to claim 28 further comprising:
determining a first lateral acceleration the vehicle is expected to reach when the driver continues driving with the current steering wheel angle.

30. The method according to claim 29 further comprising:
determining a driver action from an instantaneous lateral acceleration produced from the steering angle, vehicle speed and vehicle constants.

31. The method according to claim 29 further comprising:
determining a second lateral acceleration the vehicle is expected to reach when the driver continues driving into or out of a curve with an almost uniform steering velocity.

32. The method according to claim 29 further comprising:
determining a driver action from lateral acceleration the vehicle is expected to reach, wherein the expected lateral acceleration is produced from the steering angle speed, vehicle speed and vehicle constants.

33. The method according to claim 32, wherein the determined first and second lateral accelerations are compared with each other.

34. The method according to claim 32, wherein at least one of determined first and second lateral accelerations is compared with a limit value.

35. The method according to claim 26 further comprising:
performing brake interventions on one or more wheel.

36. The method according to claim 35, wherein the vehicle speed is reduced by performing the brake interventions.

37. The method according to claim 35, wherein an additional torque about a vertical axis of the vehicle is forced by performing the brake interventions depending on actual and nominal rotational data.

38. The method according to claim 37, wherein the actual rotational data is determined by means by a yaw rate sensor (4) and the nominal rotational data is determined from process variables in a vehicle model.

39. The method according to claim 37 signals for a pressure requirement meant for a braking pressure increase or a braking pressure decrease in the wheel brakes and producing a determined additional torque or a determined speed reduction of the vehicle are generated in a driving dynamics control, and corresponding commands are output to brake actuators.

40. The method according to claim 39, the signals for the brake pressure increase and/or the brake pressure reduction are generated depending on at least one of the variables of the lateral accelerations, the vehicle speed, the actual lateral acceleration, or the steering wheel angle.

41. The method according to claim 37, wherein the executed intervention is terminated when the expected critical driving situation or an actual critical driving situation are no longer determined.

42. The method according to claim 41, wherein the critical driving situation is no longer determined when the variables of the lateral accelerations are below predetermined threshold values.

43. The method according to claim 26, wherein a yaw rate is determined which has to be expected due to the driver action.

44. The method according to claim 43, wherein the yaw rate to be expected is compared with a limit value in order to detect a critical driving situation.

45. A system for controlling driving stability of a vehicle including sensors (1-5) measuring variables that characterize driving behavior of the vehicle, the system comprising:
a unit (8) for evaluating the measured values of the variables;
a device for generating control signals for controlling at least one of a brake intervention or an engine intervention;
a device for determining a driver action from the values of the measured variables;
a device for determining values of variables that characterize a driving dynamics of the vehicle and can be derived from the measured variables and vehicle constants (I, EG), wherein the determined values are values expected in the future due to the determined driver action;
a comparator for comparing the values of these variables to be expected with threshold values for these variables; and
a controller for controlling brake and/or engine interventions depending on the result of the comparison.

46. The system according to claim 45, wherein the measured variables are measured for an electronic driving stability control program for the vehicle.

47. The system according to claim 45, wherein the system includes at least one of a wheel speed sensor, a steering wheel angle sensor and a steering angle sensor.

48. The system according to claim 45, wherein the system includes a lateral acceleration sensor.

49. The system according to claim 45, wherein the system includes a yaw rate sensor.

50. The system according to claim 45, wherein the system is provided as component of a driving stability control system in the vehicle.

51. The system according to claim 50, wherein the driving stability control system is an ABS, TCS, ESP, ARP or similar system

52. The system according to claim 45, wherein the system is provided in a the vehicle for preventing rollover of the vehicle.
